(19) United States
(12) Patent Application Publication
(10) Pub. No.: US 2020/0020257 A1
(43) Pub. Date: Jan. 16, 2020

(54) Smart Banner Display

(71) Applicant: Proud and Pride Banners LLC, Pleasant Grove, UT (US)

(72) Inventors: Michael Joseph Mahedy, JR., Pleasant Grove, UT (US); Rix Alan Ryskamp, Mapleton, UT (US); Jayson Tyler Butcher, American Fork, UT (US)

(73) Assignee: Proud and Pride Banners LLC, Pleasant Grove, UT (US)

(21) Appl. No.: 16/580,997

(22) Filed: Sep. 24, 2019

Related U.S. Application Data
(63) Continuation-in-part of application No. 15/675,732, filed on Aug. 12, 2017, now abandoned.
(60) Provisional application No. 62/374,975, filed on Aug. 15, 2016.

(51) Int. Cl. G09F 17/00

(52) U.S. Cl. CPC G09F 17/00; G09F 2017/0025

(57) ABSTRACT

A banner display, or flag display, includes a housing that includes a shaft coupled to a motor that raises and lowers a banner, flag or similar media in response to control signals from a controller, or software. The controller may rotate the shaft in different directions based on clock information in relation to calendar information.

### CROSS-REFERENCE TO RELATED APPLICATIONS

This is a continuation-in-part of pending U.S. application Ser. No. 15/675,732 filed on Aug. 12, 2017 which in turn claims priority and benefit of 35 U.S.C. 119 to U.S. application Ser. No. 62/374,975, filed on Aug. 15, 2016. Both U.S. application Ser. No. 15/675,732 and U.S. application Ser. No. 62/374,975 are incorporated herein by reference in their entirety for all purposes.

### BACKGROUND

It may be desirable to display a banner, flag, or other signage on certain occasions. For example, it may be desirable to display a country flag to celebrate national holidays. During a local sporting event, it may be desirable to display a sports team banner and support the local team. For marketing purposes, stores may want to display signs for special sales.

It may also be desirable to conceal a banner. When inclement weather is approaching or the sun is setting for the day, one may want to conceal a banner that is on display. Also, after a special event is over, a banner is no longer needed to be on display and therefore the banner may be concealed.

For purposes of control for occasions and events, a need exists for improvements on banner displays.

### BRIEF SUMMARY

A banner display is disclosed, comprising abilities to display a flag, banner or similar media under user or automated control. “Banner display” refers to a device configured to display and/or retract a banner or flag in response to a determined condition, e.g., the expiration of a time, day, and/or date, occurrence of an event, or the like. “Flag” refers to a flexible display medium, often attached to a pole or staff, decorated with a design used as an emblem, symbol or standard or as a means of signaling. “Banner” refers to any pliable planar material configured to be rolled and unrolled around a shaft. Examples of a banner include but are not limited to, flags, team rally banners, posters, signs, pendants, and the like. A banner may be made from a variety of materials, including, but not limited to, nylon, paper, fabric, woven polyester, vinyl, laminated paper, a combination of these, or the like. In certain embodiments, a banner includes a message, insignia, logo, symbol, pattern, or other distinguishing features that associate the banner with a country, region, state, city, school, sports team, company, group, religion, franchise, or cause. “User” refers to a person that uses and/or interacts with a device or apparatus such as a banner display. In one embodiment, an apparatus is disclosed comprising a housing, a shaft extending from the housing and configured to rotate relative to the housing, a banner coupled to the shaft such that the banner extends away from the shaft as the shaft rotates in a first direction, a motor configured to rotate the shaft in response to control signals from a controller, and a controller configured to send control signals configured to activate the motor to rotate the shaft in the first direction in response to clock information satisfying calendar information. “Housing” refers to a container designed to house other components. In certain embodiments, a housing protects the components from environmental impacts such as wind, sun, moisture, etc. Housings may be made of a variety of materials, including, but not limited to, metal, wood, plastic, fabric, and the like. “Shaft” refers to a long, narrow part or section. In one embodiment, a shaft may be a rigid solid part having a cylindrical shape parallel sides and a circular or oval cross section. In one embodiment, the shaft has a longitudinal axis that passes through the center of a circle formed by the cross-section.

A shaft may be made of a variety of materials including wood, metal, cardboard, plastic, and the like. “Motor” refers to a mechanized component powered by electricity or internal combustion, that supplies motive power for a device with moving parts. In certain embodiments, the motor is a direct current (DC) electric motor configured to rotate a gear or axis in a first direction in response to current with a first polarity and to rotate the gear or axis in a second direction opposite the first direction in response to current with a polarity opposite the first polarity. “First direction” refers to one of two directions in which a shaft may rotate to enable display of a banner, flag or other display media. “Second direction” refers to one of two directions in which a shaft may rotate to enable display of a banner, flag or other display media. “Control signal” refers to electrical signals (wired or wireless) sent from a controller to a motor or other acting device for the purpose of configuring and/or activating said device.

“Clock information” refers to any data or information that relates to a present time or a current day. Clock information may originate from a variety of sources including, but not limited to, a real time clock within electronic circuitry, a server, an analog clock, a digital clock, and the like. “Real time clock” refers to any circuitry, component, chip, die, package, or module configured to track and maintain a present date and time. “Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment). “Calendar information” refers to any data, or information, that relates to a calendar. Examples of calendar information include, but are not limited to, a set of sequential dates organized into different sections or subsets such as years, seasons, quarters, months, and weeks, a set of sequential dates associated with a particular organization, group, event, celebration, holiday, cause, or policy, a schedule of dates and/or times of day for a certain event, celebration, or holiday. Calendar information may include a particular time and/or date, or a series of times and/or dates, that recur each day, week, month, year, or season.

In another embodiment, a system is disclosed comprising a housing, a shaft within the housing, a banner coupled to the shaft such that one end of the banner extends away from the shaft and retracts towards the shaft as the shaft rotates in opposite directions, and a motor located within the housing, the motor configured to rotate the shaft based on control signals from a controller configured to manage calendar information and clock information, the controller configured to send control signals to the motor to rotate the shaft in one direction in response to the clock information satisfying a schedule based on calendar information. “End of the banner” refers to the physical limit of a banner, flag, or similar display, typically at the opposite end of where said display may be attached to a fixed apparatus (e.g., flagpole). “Flagpole” refers to a pole on which a flag is raised.

In yet another embodiment, a method is disclosed comprising managing calendar information for a banner display, the calendar information comprising a schedule, determining whether a current date satisfies the schedule, and triggering a banner display action by a banner display in response to the current date satisfying the schedule. “Banner display action” refers to any action that a banner display is configured to perform either alone or in combination with one or more accessories and/or one or more sensors. Examples of a banner display action include, but are not limited to, displaying a banner, retracting a banner, positioning the banner, changing lighting for a banner, partially displaying a banner, partially retracting a banner, playing an audio clip, sounding an alert, a determination whether environmental conditions support displaying or retracting a banner, a determination whether a time of day satisfies a schedule for displaying or retracting a banner, and the like. “Alert” refers to a condition or period of heightened watchfulness or preparation for action. “Audio clip” refers to an audible piece of music or sound of short duration, typically played back as part or whole of a computer file on a suitably enabled device. “One or more sensors” refers to a plurality of sensors to measure conditions such as weather, humidity, light, motion, and so on. “One or more accessories” refers to visual and auditory enhancements to the flexible banner display, including but not limited to enhanced lighting and sound. “Current date” refers to the current month, day, day of the week, and year.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a banner display 100 in accordance with one embodiment.

FIG. 2 illustrates a banner display 200 in accordance with one embodiment.

FIG. 3 illustrates a cross-section views of a housing and a shaft 300 in accordance with one embodiment.

FIG. 4 illustrates a banner display 400 in accordance with one embodiment.

FIG. 5 illustrates a side view of a banner display 500 in accordance with one embodiment.

FIG. 6 illustrates a banner display 600 in accordance with one embodiment.

FIG. 7 illustrates a banner display 700 in accordance with one embodiment.

FIG. 8 illustrates a banner display 800 in accordance with one embodiment.

FIG. 9 is an example block diagram of a computing device 900 that may incorporate certain embodiments.

FIG. 10 illustrates a networked environment 1000 in accordance with one embodiment.

FIG. 11 illustrates a banner display use case 1100 in accordance with one embodiment.

FIG. 12 illustrates a banner display use case 1200 in accordance with one embodiment.

FIG. 13 illustrates a banner display use case 1300 in accordance with one embodiment.

FIG. 14 illustrates a routine in accordance with one embodiment.

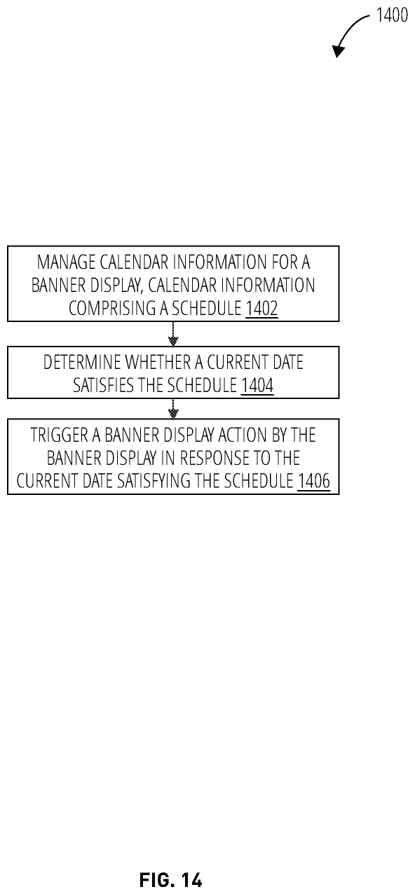

### DETAILED DESCRIPTION

A smart banner display includes a housing and a shaft located within the housing. The shaft is configured to rotate around an axis relative to the housing. A banner is removably attached to the shaft so that the banner is raised and lowered as the shaft rotates. A motor rotates the shaft in any rotational direction based upon communication from a controller.

A method for controlling a smart banner display includes displaying on a user interface one or more input controls related to control of the banner display. Upon receiving a selection of the one or more input controls, the method includes providing the selection to a controller. Based on the selection, the controller performs a banner display action which may include positioning the banner, lighting up the banner, or other banner display action.

Another method for controlling a smart banner display includes monitoring, through an application, external event information. Upon detecting a trigger condition based on one or more events, the method includes performing a banner display action.

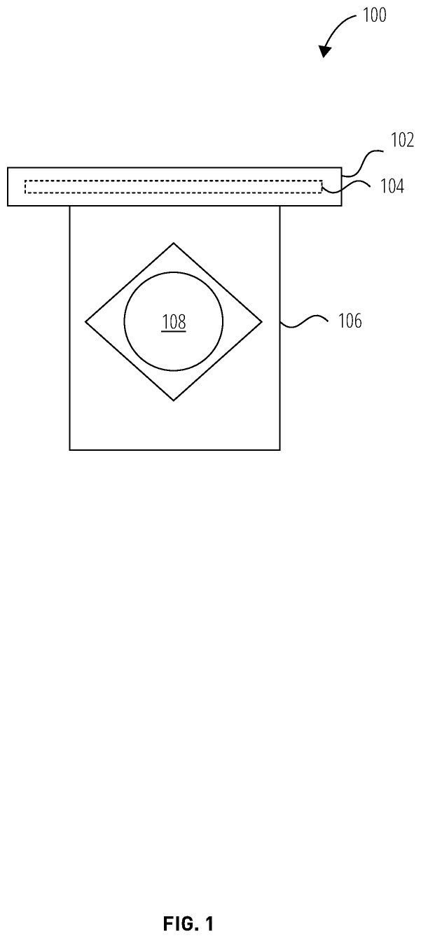

FIG. 1 depicts a banner display 100 including a housing 102, a shaft 104, and banner 106. The housing 102 is a protective shell that holds the shaft 104, banner 106, and components that control the display and retraction of the banner 106. Such control of the display may be done manually or automatically and may further utilize wireless technology.

The banner display 100 raises and lowers the banner 106. In certain embodiments, the banner display 100 includes a lighting component configured to light up the display at nighttime, in low light conditions, or to shine extra light on the banner 106 and make banner 106 stand out. Also, sensors may be used to sense weather conditions and provide weather data to control the display of the banner 106. Also, various power sources may be utilized to power the device.

The banner display 100 may be hung or attached by the housing 102 to a house, building, or other structure. For example, ropes or cables may tether the housing 102 to a structure. Brackets, bolts, rivets, and other mechanical fasteners may also be used. In one example, the banner display 100 may be hung underneath an awning of a house.

The banner 106 may be a banner, flag, signage, or other display unit that is housed in the banner housing. The banner 106 may include a design 108 or logo of a variety of shapes, sizes, and colors. The banner 106 may be made of cloth, plastic, a plastic-coated fabric, or other material, and of a shape that is typically oblong, square, rectangular, triangular, or other shape. The banner 106 is typically flexible so that banner 106 can be rolled or folded or otherwise arranged so as to be concealed within the housing 102 when retracted or raised. The shaft 104 and components, including electrical components, motors, sensors, etc., may be operatively connected to the shaft 104.

“Banner” refers to any pliable planar material configured to be rolled and unrolled around a shaft. Examples of a banner, include but are not limited to, flags, team rally banners, posters, signs, pendants, and the like. A banner may be made from a variety of materials, including, but not limited to, nylon, paper, fabric, woven polyester, vinyl, laminated paper, a combination of these, or the like. In certain embodiments, a banner includes a message, insignia, logo, symbol, pattern, or other distinguishing features that associate the banner with a particular country, region, state, city, school, sports team, company, group, religion, franchise, or cause.

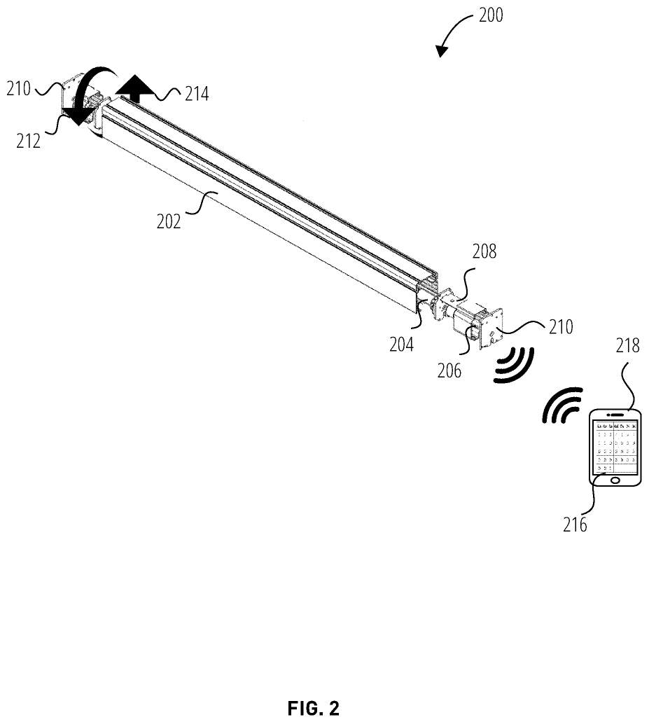

FIG. 2 illustrates an exploded view of a banner display 200. Banner display 200 includes a housing 202, a shaft 204, a motor 206, and a controller 208 (the banner is not shown in FIG. 2 for clarity). In one embodiment, the housing 202 encloses the other components of the banner display 200 and provides structure support for the operation of the banner display 200. In one embodiment, the housing 202 is configured to be water resistant such that the banner display 200 may operate outdoors. In one embodiment, the housing 202 is elongated and configured to house the shaft 204, banner, motor 206, and controller 208. “Motor” refers to a mechanized component powered by electricity or internal combustion, that supplies motive power for a device with moving parts. In certain embodiments, the motor is a direct current (DC) electric motor configured to rotate a gear or axis in a first direction in response to current with a first polarity and to rotate the gear or axis in a second direction opposite the first direction in response to current with a polarity opposite the first polarity. The housing 202 may include a mounting assembly 210 such as brackets, slots in the housing 202 (not shown), hooks (not shown), eyelets (not shown), or the like. When installed, the housing 202 may typically be oriented substantially horizontal, e.g., substantially parallel to ground level. “Housing” refers to a container designed to house other components. In certain embodiments, a housing protects the components from environmental impacts such as wind, sun, moisture, etc. Housings may be made of a variety of materials, including, but not limited to, metal, wood, plastic, fabric, and the like.

The shaft 204 may extend from one end of the housing 202 to the other end of the housing 202. On one end of the housing 202, the shaft 204 may engage a pin or recess such that the shaft 204 may rotate about its longitudinal axis. On another end of the housing 202, the shaft 204 may engage a motor 206 such that activation of the motor 206 in a first direction 212 causes the shaft 204 to spin about its longitudinal axis in the first direction 212 and activation of the motor 206 in a second direction 214, the opposite direction, causes the shaft 204 to spin about its longitudinal axis in the second direction 214. In one embodiment, the shaft 204 and housing 202 are an integrated unit. In one embodiment, the shaft 204 holds the banner in a rolled state within the housing 202. Rotational movement of the shaft 204 in the first direction 212 unrolls the banner for display. Rotational movement of the shaft 204 in the opposite direction (second direction 214) rolls up the banner for concealment.

The motor 206 in one embodiment is an electrical motor configured to rotate the shaft 204 in response to a command and/or in response to a current. In one embodiment, the motor 206 rotates the shaft 204 in a first direction 212 in response to a current flowing in one direction through a circuit that includes the motor 206 and rotates the shaft 204 in a second direction 214 in response to a current flowing in an opposite direction through a circuit that includes the motor 206.

In one embodiment, the controller 208 manages the operation of the banner display 200. Various types of controllers having a variety of features may be used with different embodiments of the banner display 200. In one embodiment, the controller 208 comprises a printed circuit board comprising a plurality of electronic components organized into one or more circuits for performing the features and functions of the controller 208.

“Controller” refers to any hardware, software, firmware, circuit, electronic component, module, logic, device, or apparatus configured, programmed, designed, arranged, or engineered to manage, direct, and/or control other circuits, modules, electronic components, devices, and the like. Examples of a controller include, but are not limited to, logic or software executed by a CPU, a SoC, a single board computer, a state machine, a FPGA, or other processor. “Memory” refers to any hardware, circuit, component, module, logic, device, or apparatus configured, programmed, designed, arranged, or engineered to retain data. Certain types of memory require availability of a constant power source to store and retain the data. Other types of memory retain and/or store the data when a power source is unavailable. “Logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). “Software” refers to Logic implemented as processor-executable instructions in a machine memory (e.g. read/write volatile memory media or non-volatile memory media). “Non-volatile memory media” refers to any hardware, device, component, element, or circuit configured to maintain an alterable physical characteristic used to represent a binary value of zero or one after a primary power source is removed. “Volatile memory media” refers to any hardware, device, component, element, or circuit configured to maintain an alterable physical characteristic used to represent a binary value of zero or one for which the alterable physical characteristic reverts to a default state that no longer represents the binary value when a primary power source is removed or unless a primary power source is used to refresh the represented binary value. Examples of volatile memory media include but are not limited to dynamic random-access memory (DRAM), static random-access memory (SRAM), double data rate random-access memory (DDR RAM) or other random access solid state memory

While the volatile memory media is referred to herein as “memory media,” in various embodiments, the volatile memory media may more generally be referred to as volatile memory.

In certain embodiments, data stored in volatile memory media is addressable at a byte level which means that the data in the volatile memory media is organized into bytes (8 bits) of data that each have a unique address, such as a logical address. “Volatile memory” refers to a shorthand name for volatile memory media. In certain embodiments, volatile memory refers to the volatile memory media and the logic, controllers, processor(s), state machine(s), and/or other periphery circuits that manage the volatile memory media and provide access to the volatile memory media. “Processor” refers to any circuitry, component, chip, die, package, or module configured to receive, interpret, decode, and execute machine instructions. Examples of a processor may include, but are not limited to, a central processing unit, a microprocessor, a general-purpose processor, an application-specific processor, a graphics processing unit (GPU), a field programmable gate array (FPGA), Application Specific Integrated Circuit (ASIC), System on a Chip (SoC), virtual processor, processor core, and the like. “Firmware” refers to Software logic embodied as processor-executable instructions stored on volatile memory media and/or non-volatile memory media. “Hardware” refers to Logic embodied as analog and/or digital circuitry.

Among other functions and features managed by the controller 208, the controller 208 manages extending and retracting the banner 106. In one embodiment, the controller 208 sends a control signal to activate the motor 206 which rotates the shaft 204 in a first direction 212 to unroll the banner for display. The controller 208 may send a different control signal to activate the motor 206 to rotate the shaft 204 in the opposite direction (second direction 214) to roll up the banner for concealment. “Control signal” refers to electrical signals (wired or wireless) sent from a controller to a motor or other acting device for the purpose of configuring and/or activating said device.

In one embodiment, the controller 208 is configured to send control signals in response to one or more conditions and/or triggers being met. For example, in one embodiment, the controller 208 sends a control signal a condition that clock information satisfies certain calendar information. “Clock information” refers to any data or information that relates to a present time or a current day. Clock information may originate from a variety of sources including, but not limited to, a real time clock within electronic circuitry, a server, an analog clock, a digital clock, and the like. One example of clock information is a time of day as reported by a clock. In one embodiment, the controller 208 comprises a clock used to determine clock information. In another embodiment, the controller 208 communicates with a host to determine clock information.

“Clock information” refers to any data or information that relates to a present time or a current day. Clock information may originate from a variety of sources including, but not limited to, a real time clock within electronic circuitry, a server, an analog clock, a digital clock, and the like. One example of clock information is a time of day as reported by a clock. In certain embodiments, the clock information may include the current time, date, day of the week, month or the year, and year. In one embodiment, the controller 208 comprises a clock used to determine clock information. In another embodiment, the controller 208 communicates with a host or other circuitry or device to determine clock information.

In another embodiment, the controller 208 comprises a transceiver within the housing 202 and logic implemented within a remote device such as a mobile device, a server, a host, a laptop, a tablet, or the like. “Remote device” refers to any hardware, software, firmware, circuit, electronic component, module, logic, device, mechanical device, digital device, or apparatus configured, programmed, designed, arranged, or engineered to manage, direct, and/or control a banner display. Examples of a remote device include, but are not limited to, a mobile device executing a software application, a computer server, a hand-held controller configured to communicate with a banner display wirelessly using radio waves, or infrared waves, or the like. In such an embodiment, the controller 208 may independently, or in collaboration with other circuitry determine that clock information satisfies calendar information an send control signals to the transceiver by way or a wired or wireless communication channel such that the transceiver delivers the control signals to the motor 206 to rotate the shaft 204.

In one embodiment, the controller 208 monitors the clock information and calendar information to determine when clock information satisfies calendar information.

“Calendar information” refers to any data, or information, that relates to a calendar. Examples of calendar information include, but are not limited to, a set of sequential dates organized into different sections or subsets such as years, seasons, quarters, months, and weeks, a set of sequential dates associated with a particular organization, group, event, celebration, holiday, cause, or policy, a schedule of dates and/or times of day for a certain event, celebration, or holiday. Calendar information may include a particular time and/or date, or a series of times and/or dates, that recur each day, week, month, year, or season.

In one embodiment, the calendar information comprises a schedule for when the banner is to be lowered/extended and raised/retracted each day. The schedule indicate an extension operation and retraction operation each day of a week, at certain times during one or more days, or for specific times and specifics days of certain months such as for a special occasion or particular event.

In one embodiment, the controller 208 derives a set of triggers or conditions or rules for operating the banner from clock information. For example, the calendar information may indicate that the banner is to be displayed during daylight hours on July 4th, e.g., a national holiday. The controller 208 may reference clock information and other calendar information to determine which day in a particular year the banner is to be displayed and during which times.

In one embodiment, the calendar information 216 comprises data within a mobile device 218. Alternatively, the calendar information 216 may reside in memory or storage of the controller 208.

In one embodiment, the controller 208 comprises a computing device 900 configured to perform the functions and provide the features of the controller 208. In such an embodiment, the computing device 900 may include software configured to accept and respond to voice commands. The voice commands may be detected by the computing device 900 and implemented to carry out a variety of functions using the banner display 200. Further, in such an embodiment the computing device 900 may be configured to communicate with software over a network to enable remote control and operation of the computing device 900.

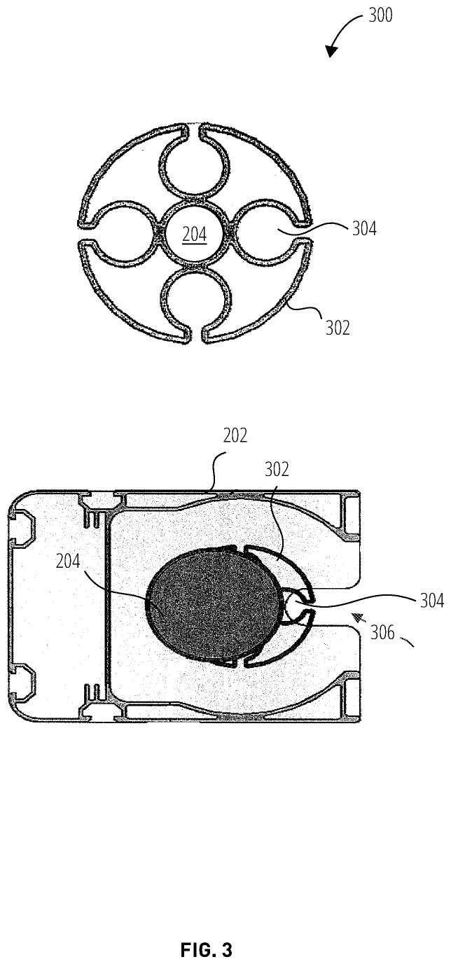

FIG. 3 illustrates cross-section views of a housing and a shaft 300 comprising the housing 202 with the shaft 204, banner insert 302, inlet 304, and opening 306.

The housing 102 and shaft 204 provide openings in which an end of a banner 106 may be inserted on the open side of the housing 102. The housing 102 includes the opening 306, which may comprise a slotted opening or other opening. The opening allows further entry to the banner insert 302 which holds the banner to the shaft 204. The banner insert 302 itself is a generally rounded member that extends radially from a central axis of the shaft 204 and which extends lengthwise along the length of the shaft 204. The banner insert 302 includes an inlet 304 which has a narrow opening that leads to a larger inner opening. An edge of a banner is inserted through the inlet 304 and along the length of the banner insert 302 so that it generally spans the length of the shaft 204. In one embodiment, the banner has a thicker end so that it is held in place by the larger inner opening constrained by the narrow opening of the inlet 304. In one embodiment, the banner 106 includes a dowel or rod on one end sized to snap within the larger inner opening. Other structures, including structures with locking means and adjustment means, may be used to attach the banners to a shaft 204.

Note that in this configuration multiple banners can be used together, e.g., the banner can be removably attached to the shaft 204 such that the shaft 204 is useable with a plurality of banners. This may be accomplished with one shaft 204 or multiple shafts. It is also possible that multiple banner displays 200 be connected together, by way of a common controller 208 in a manner that allows for simultaneous control.

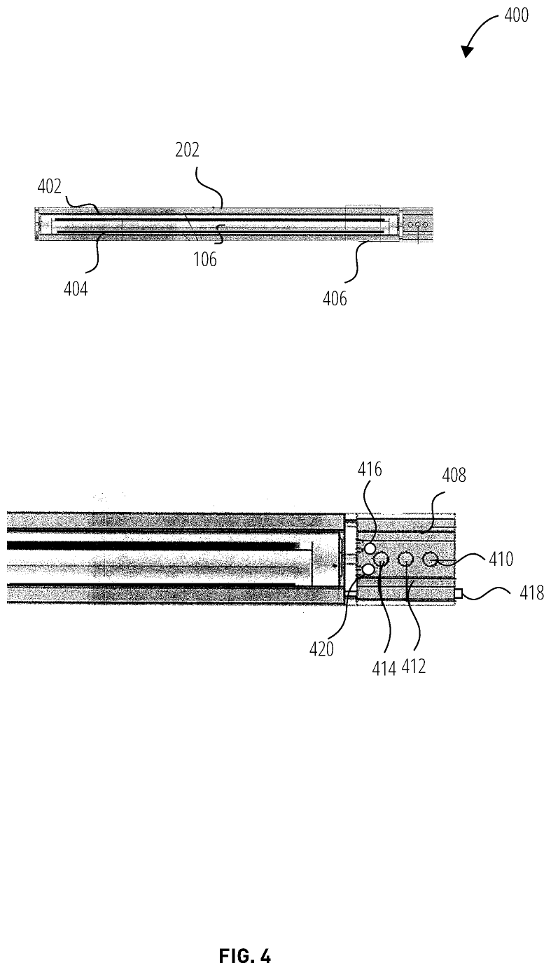

Referring to FIG. 4, a banner display 400 is illustrated. Specifically, FIG. 4 illustrates a bottom view of the housing 202. The housing 202 includes lighting 402 and lighting 404 on either side of a housing 202 to selectively light up either, or both sides of the banner 106. In one embodiment only one lighting element may be used. In another embodiment, two or more lighting elements may be used, either on the front side of a banner, back side of the banner, or illuminating both sides. Lighting elements may be comprised of different colors (e.g., combinations of red light, green light, and blue light, or RGB). The lighting elements may emit continual illumination or vary in the amount of illumination emitted over time, including blinking (on/off), pulsing (variance in illumination strength), flashing and so on. Lighting 402 and lighting 404 may comprise LED lights, incandescent lights, spotlights, neon lights, florescent lights or other lighting elements known to those skilled in the art for illuminating banners or display media. Lighting may additionally take several forms, including but not limited to bulbs, strips, panels, strings, and pin lights.

A banner identifier 406 may be attached to the housing 202. The banner identifier 406 may be used to read RFID tags of the banners. RFID tags may be used to identify the banner 106 and may further be used to track the location of the banner 106 (e.g., whether the banner is in an extended position or retracted position). “Retracted position” refers to a display state of a banner, flag, or similar display wherein said display retracts into its housing or similar encasement. “Extended position” refers to a display state of a banner, flag, or similar display wherein the banner is shown partially or in its entirety.

In one embodiment, the controller 208 comprises a sensor module 408. “Sensor module” refers to a device, component, circuit, system, chip, or circuitry configured to detect and/or measure one or more characteristics relating to an environment. A sensor module, in one embodiment, detects and/or measures levels of certain features such as light, temperature, humility and the like. In another embodiment, the controller 208 is coupled to the sensor module 408 by way of a communication channel such as data bus. In one embodiment, the sensor module 408 is integrated with the controller 208. In another embodiment, the sensor module 408 is separate from the controller 208.

The sensor module 408 provides measurement data and/or signals for a variety of conditions and/or circumstances including environmental conditions such as weather, motion in the vicinity of the banner display 100, sound detection, and the like. The sensor module 408 comprises one or more sensors including, but not limited to, a wind sensor 410, a rain sensor 412, a motion sensor 414, a light sensor 416, temperature sensor 420, and the like. According to certain embodiments, additional sensors may be included to account for other environmental conditions. In one embodiment, the one or more sensors are integrated with the sensor module 408. In another embodiment, one or more sensors may be separate from, but linked to the sensor module 408.

In one embodiment, the banner display 400 includes a power input 418 for connecting to a power supply. “Power supply” refers to any circuitry, component, chip, die, package, or module configured to supply a sufficient amount of power to operate the features and functions of a banner display. In certain embodiments, a power supply may comprise a domestic power supply source from a residential power plant, a battery system, a solar power supply system, a wind generator system, or the like. The power input 418 may connect to a direct current (DC) power supply by way or an Alternating Current (AC) adapter or DC power supply from a solar power module.

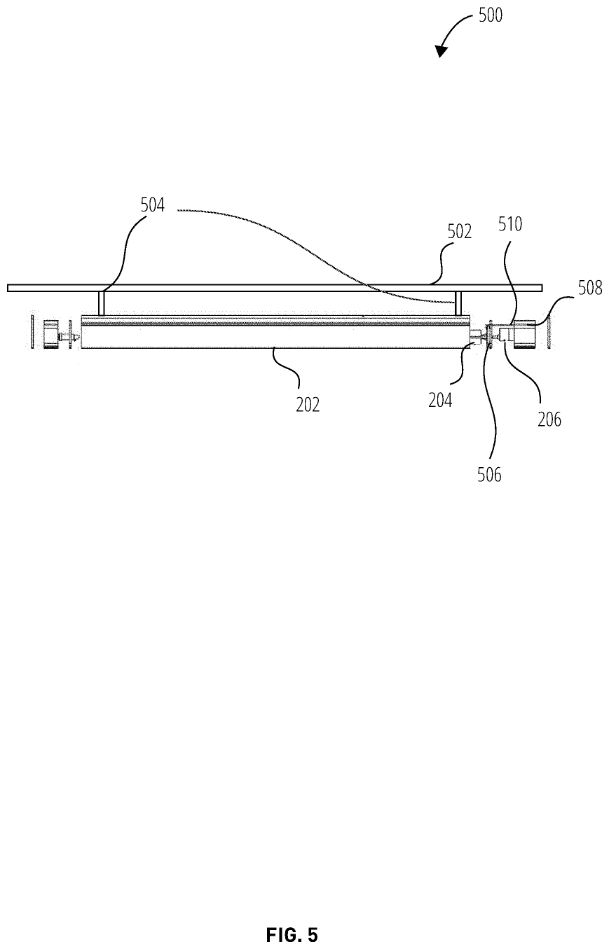

Referring to FIG. 5, a side view of a banner display 500 is shown. In one embodiment, the housing 202 includes mounting system 504 configured to connect the banner display 200 to a mount site 502. “Mounting system” refers to an apparatus or similar hardware configuration by which a housing for a banner display may be affixed to a structure or other display area. “Mount site” refers to a location where the housing of a banner display may be affixed to a structure or other display area. In one embodiment, the mounting system 504 is configured to permit removal and reinstallation of the banner display 200 by a user. For example, the mounting system 504 may comprise a set of hooks and/or chains that a user can readily attached or detach as the banner display 200 is installed or removed.

In certain embodiments the housing 202 may be sized and configured to hold a plurality of banners, each banner attached to its own shaft, for the purpose of displaying a different banner under varying circumstances as otherwise described herein (e.g., a change in calendar information). The shaft 204 in such an embodiment may also be removably coupled to the motor 206 in an embodiment in which the motor 206 rotating the shaft may select and rotate a single banner at a time. In such an embodiment, the selector 506 may be implemented as a gear box and/or transmission connected to the motor 206. In such an embodiment, the controller 508 may direct the gear box to change the gearing such that a different banner is coupled to the motor 206.

The motor 206 thereby may similarly power any one of a plurality of shafts, such that a plurality of shafts within the housing 202 can be useable with a matching plurality of banners. In addition to switching between a plurality of shafts (i.e., decoupling the motor 206 from one of a plurality of shafts and engaging the motor 206 to a different shaft 204), the selector 506 may determine which banner to use at any given time, operating in response to a control signal 510 from the controller 508. “Selector” refers to any hardware, device, component, element, or circuit configured to decouple a motor from one shaft and engage the motor to a different shaft. In this case, the controller 508 may send instructions as a control signals to the selector 506, which responds by selecting from among a plurality of shafts to which the motor 206 couples to rotate under the power of the motor 206.

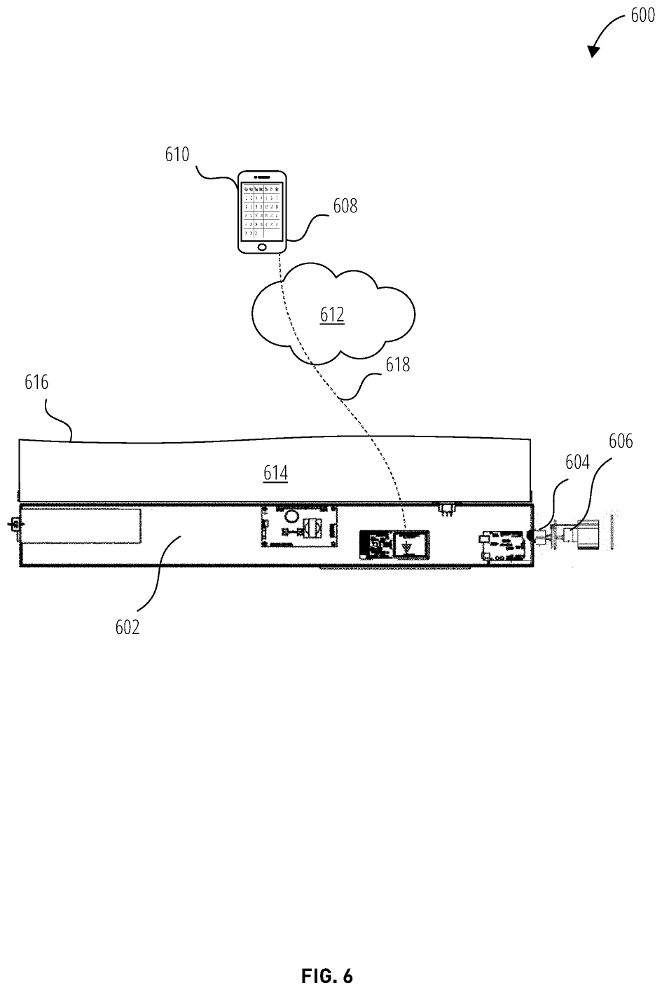

Referring to FIG. 6, a banner display 600 is illustrated. The banner display 600 includes a housing 602, a shaft 604, and a motor 606. The housing 602, shaft 604, and motor 606 may operate in similar manner to like components described above in relation to other embodiments.

In the illustrated embodiment, the banner display 600 may include controller 608. In certain embodiments, the controller comprises logic that is contained within the controller and the controller resides within the banner display. In other embodiments, the controller comprises logic that is contained within the controller and the controller resides outside the banner display and the banner display includes minimal logic and/or hardware to communicate with the controller and implement control signals from the controller.

Controller 608 comprises logic positioned outside the housing 602, and in certain embodiments, remote from the housing 602. In the depicted banner display 600, the housing 602 may include certain hardware and/or logic, such as a portion of communication module, for communicating with the controller 608. For example, the housing 602 may include a wireless transceiver configured to communicate with the controller 608 using wireless technologies such as Bluetooth or other radio frequencies. The housing 602 may also include a processor for receiving the control signals and implementing them to activate the motor 606 and/or other accessories of the banner display 600. In another embodiment, the motor 606 and/or other accessories may include logic for communicating with and responding to the controller 608 integrated into the motor 606 and/or other accessories.

The motor 606, can be configured to rotate the shaft 604 as described above based on control signals or a control signal 618 received from the controller 608. Note in this embodiment the controller 608 is located within a remote device 610 (e.g., a mobile device with installed software). In one embodiment, the controller 608 sends the control signals via a standard IP network 612 to be received by a communication module located within the housing 202 assembly. “Communication module” refers to any hardware, software, firmware, circuit, electronic component, module, logic, device, or apparatus configured, programmed, designed, arranged, or engineered to manage, direct, and/or control analog or digital communications between two electronic components. A communication module may use a variety of signal transfer media including wired and wireless interconnects (such as Bluetooth, Radio Frequency (RF), or Wi-fi technology (e.g. radio or chip)).

The controller 608 may manage both calendar information (e.g., particular dates, holidays, special events, weekends, days of the week, and so on) and specific clock information (e.g., hours, minutes, seconds) and correlate information with a schedule maintained in a data structure within an application executing on the remote device 610. Clock information may satisfy a condition defined in the schedule based on the calendar information in various ways. For example, 12:00 am on December 31 (e.g., clock information) may satisfy the condition defined in, or by, the schedule based on the calendar information as New Year's Eve. An exact time on a given date may satisfy the condition defined in the schedule based on the calendar information as an individual's (precise) birthday. As another example, 12:00 am on any Monday morning satisfies the condition defined in the schedule based on the calendar information as a start of a work week. When the clock information satisfies the condition defined in the schedule based on the calendar information the controller 608 sends control signals, in the displayed embodiment via the network 612, to the motor 206 to rotate the shaft 104 in one direction, to extend or retract the banner 106, either partially or completely.

The banner display 600 includes a banner 614 coupled to the shaft 604 and extends away from the shaft 604 and housing 602. One end of the banner 616 extends away from the shaft 604 when displayed and conversely retracts toward the shaft 604 when concealed, the shaft 604 rotating in opposite directions to accommodate extension and retraction, respectively. The motor 606 rotates the shaft 604, as explained above in FIG. 3.

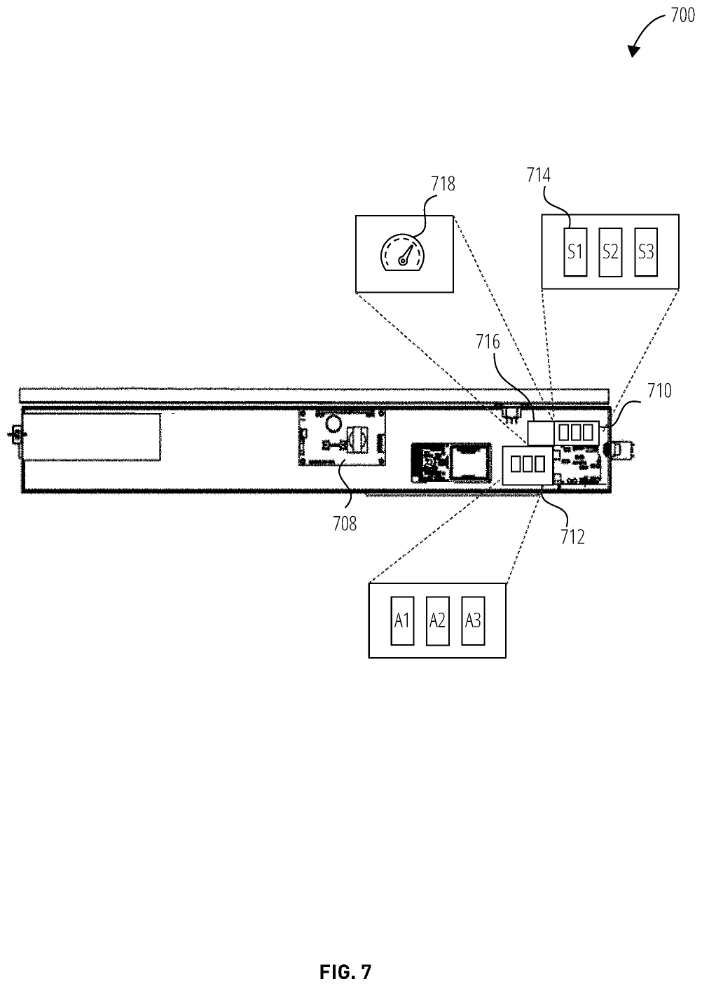

FIG. 7 illustrates one embodiment of a banner display 700. In this embodiment, the housing, shaft, and motor may be substantially similar to embodiments, described previously. In this embodiment, the controller 708, is coupled to one or more sensors 710 (S1, S2, S3, etc.) and one or more accessories 712 (A1, A2, A3, etc.). The controller 708 may be coupled to the one or more sensors 710 by one or more of circuitry on a printed circuit board, wired connections, wireless connections, and the like.

The one or more sensors 710 detect one or more attributes about the banner display 700 and its environment. For example, one sensor may detect motion near the banner display 700. Another sensor may detect ambient temperature. Another sensor may detect ambient lighting conditions. Another sensor may detect weather conditions, such as barometric pressure, wind, or humidity. Examples of the one or more sensors 710 may comprise a photocell, weather sensor, temperature sensor, wind sensor, and various other components. Those of skill in the art will appreciate that while certain sensors are enumerated here, the embodiments recited in the claims are not limited to just these sensors and that other suitable sensors may be used with the banner display 700 to enable other features and functions. The one or more sensors 710 provide readings or signals to the controller 708. The controller 708 uses these readings and signals to determine how to manage the banner display 700. For example, in response to a reading from a wind sensor that the wind is blowing beyond a threshold, the controller 708 may signal the motor to retract the banner.

The controller 708 may use certain sensors of the one or more sensors 710 to manage operation of the banner display 700. For example, the one or more sensors 710 may include a banner position sensor 714 that signals the position of the banner. “Banner position sensor” refers to one or more sensors with the ability to determine position of an object, in this case, one or more sensors determining the position (i.e., extended position, retracted position, or otherwise) of a banner or flag. In one embodiment, a banner position sensor 714 sends a first signal to the controller 708 to indicate that the banner is fully extended. The banner position sensor 714 may send a second signal to the controller 708 to indicate that the banner is fully retracted. By using a banner position sensor 714 the banner display 700 may accommodate banners of varying lengths. In another embodiment, the banner position sensor 714 may send a third signal to the controller 708 to indicate that the banner is positioned somewhere between fully extended and fully retracted. For example, the third signal may indicate that the banner is extended half-way.

In certain embodiments, the banner display 700 includes one or more accessories 712 coupled to the controller 708. The one or more accessories 712 may be coupled to the controller 708 by way of circuitry on a printed circuit board, wired connections, wireless connections, and/or the like. As used herein, an accessory comprises any hardware, circuitry, logic, component, or device configured to provide or supplement a feature or function of the banner display 700. In one embodiment, the accessories comprising visual and auditory enhancements to the banner display. Exemplary accessories may include, but are not limited to, speakers, laser lighting, fog generators, visual projection devices, and other components emitting enhanced visual and sound effects. While a few examples of accessories are described herein, those of skill in the art will appreciate that the banner display 700 may be adapted to include other accessories not described here. Those of skill in the art will appreciate that the embodiments recited in the claims are not limited to just the enumerated accessories and that other suitable accessories may be used with the banner display 700 to enable other features and functions.

One embodiment of the banner display 700 includes a banner identifier 716 coupled to the controller 708. The banner identifier 716, in one embodiment, detects which banner is installed in the banner display 700 and determines if this is the same banner that the controller expects is installed in the banner display 700. “Banner identifier” refers to any module, hardware, software, firmware, component, or device alone or with one or more tags that is capable of identifying the size, type, and shape of a flag or banner. In one embodiment, the banner identifier identifies the size, type, and shape of a flag or banner without using the services of any other components. In another embodiment, the banner identifier identifies the size, type, and shape of a flag or banner in collaboration with another component such as a controller or processor.

In one embodiment, the banner identifier 716 employs Radio Frequency Identification (RFID) technology to determine which banner is installed in the banner display 700. In such an embodiment, the banner identifier 716 may comprise a sensor configured to detect and interpret an RFID tag secured to a banner, or connected to the banner material. The RFID tag may uniquely identify one banner from another. In one embodiment, the position of the RFID tag on the banner relative to the position of the sensor of the banner identifier 716 may be used to implement a banner position sensor 714 such that the banner identifier 716 may be used to determine the location of the banner relative to the shaft. For example, if the banner identifier 716 is stationary and the RFIG tag is placed at the end of the banner 616, the banner identifier 716 may use the distance of the RFIG tag from the banner identifier 716 to determine banner position.

Information associated with an identified banner may include the type of banner, dimensions, such as length, display settings and configurations for the type of banner, and other types of information. In this manner, banners may be exchanged for other banners. By using the banner identifier 716 the controller can adjust or adapt settings and configuration parameters used to display the banner.

Advantageously, the banner display 700 is configured to receive and operate with a variety of different sizes and types of banners. Each banner may have a different requirement for how far the banner extends when in an extended position and/or in a retracted position. The controller may manage the distance a banner extends when in an extended position and/or in a retracted position using a rotation count.

“Rotation count” refers to a number of whole rotations of a shaft required to place a banner connected to the shaft in a predefined extended position and/or retracted position. Because the variation in length of a banner that may be installed in a banner display, the rotation count may also vary between different banners.

In one embodiment, the controller changes a rotation count based on the type of banner installed, which is identified using the banner identifier. With a rotation count as a threshold, the controller 708 can operate the motor to extend or retract the banner to a desired position. In certain embodiments, the controller 708 uses the rotation count 718 together with the banner position sensor 714 to accurately position an end of the banner relative to the housing and shaft.

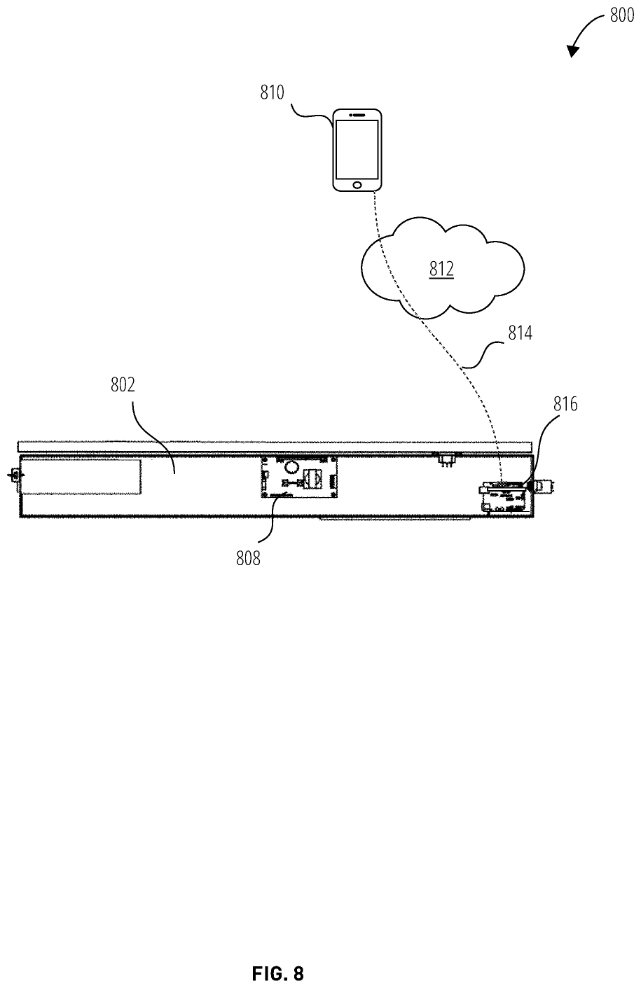

Referring to FIG. 8, an interior view of a banner display 800 is shown. The depicted embodiment includes a housing 802, shaft (not shown), and motor (not shown), and a controller 808 that resides within the housing 802.

In the depicted embodiment of FIG. 8, the banner display 800 includes a communication module 816 coupled to the controller 808. “Communication module” refers to any hardware, software, firmware, circuit, electronic component, module, logic, device, or apparatus configured, programmed, designed, arranged, or engineered to manage, direct, and/or control analog or digital communications between two electronic components. A communication module may use a variety of signal transfer media including wired and wireless interconnects (such as Bluetooth, Radio Frequency (RF), or Wi-fi technology (e.g. radio or chip)). The communication module 816 may communicate commands, data, receiving input, and/or signals from and to a remote device 810

In one embodiment, the remote device 810 exchanges operation data 814 with the controller 808 by way of the communication module 816. “Operation data” refers to data related to operation of the banner display including but not limited to detecting trigger conditions, actuating the banner display, activating accessories and any other operations under control of an application installed on the remote device. “Trigger condition” refers to any external event information in combination with a condition and a threshold. A trigger condition is satisfied when the external event information meets the threshold according to the condition. In one embodiment, the trigger condition comprises a trigger event which a controller can detect and in response to the detected trigger event the controller can activate a banner feature relating to that trigger external event information.

One example trigger condition may be when the date is May 1st each year a certain banner is to be displayed. Another example trigger condition may be when a particular sports team wins a particular sporting event, a banner for that team is to be displayed for three days following the sporting event. Another example trigger condition may be when a particular rival sports team loses a particular sporting event, a banner for a particular team is to be displayed for two days following the sporting event. Another example trigger condition may be when ambient light conditions fall below a certain threshold all banners are to be retracted. Another example trigger condition may be when wind gusts exceed a predefined level, (e.g., miles per hour), all banners are to be retracted.

The remote device 810 and communication module 816 may communicate over a network 812 such as an Internet Protocol (IP) network.

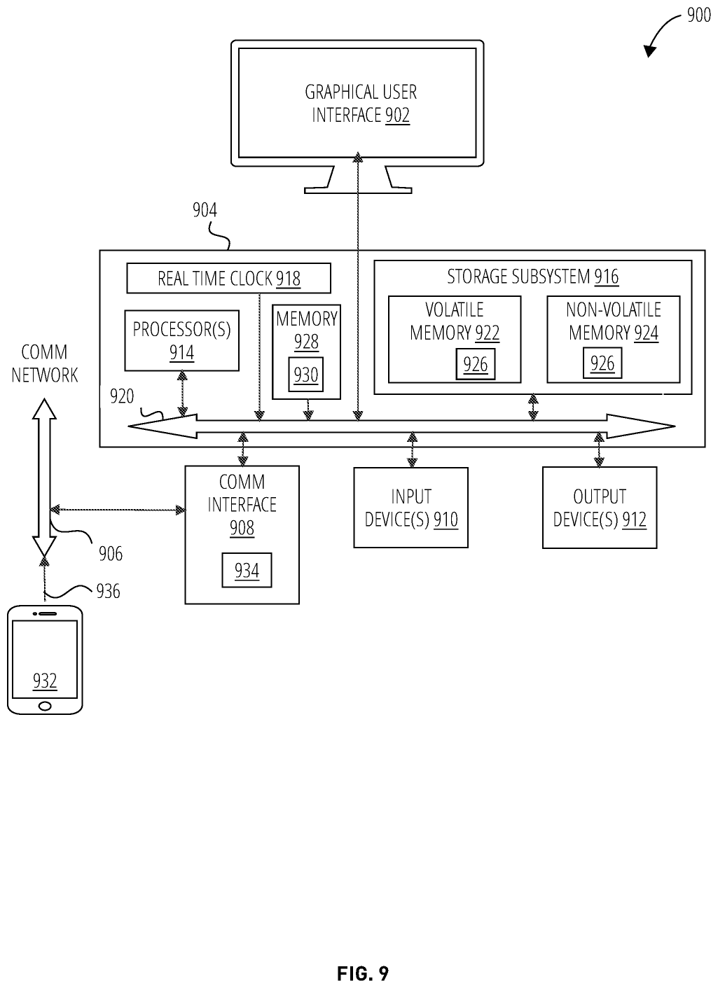

FIG. 9 is an example block diagram of a computing device 900 that may incorporate embodiments of the solution. For one embodiment, the computing device 900 may be used to implement a controller as recited in one or more claims of this disclosure. FIG. 9 is illustrative of a machine system to carry out aspects of the technical processes described herein, and does not limit the scope of the claims. One of ordinary skill in the art would recognize other variations, modifications, and alternatives. In certain embodiments, the computing device 900 includes a graphical user interface 902, a data processing system 904, a communication network 906, communication network interface 908, input device(s) 910, output device(s) 912, and the like.

As depicted in FIG. 9, the data processing system 904 may include one or more processor(s) 914, a storage subsystem 916, and a real time clock 918. “Processor” refers to any circuitry, component, chip, die, package, or module configured to receive, interpret, decode, and execute machine instructions. Examples of a processor may include, but are not limited to, a central processing unit, a microprocessor, a general-purpose processor, an application-specific processor, a graphics processing unit (GPU), a field programmable gate array (FPGA), Application Specific Integrated Circuit (ASIC), System on a Chip (SoC), virtual processor, processor core, and the like. The processor(s) 914 communicate with a number of peripheral devices via a bus subsystem 920. In one embodiment, the processor(s) 914 is configured to send control signals when clock information satisfies calendar information.

The peripheral devices may include input device(s) 910, output device(s) 912, communication network interface 908, and the storage subsystem 916. The storage subsystem 916, in one embodiment, comprises one or more storage devices and/or one or more memory devices. “Storage device” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like. The real time clock 918 provides time information such as clock information for devices of the computing device 900, relaying time to the accuracy required (e.g., milliseconds) as needed. In one embodiment, the real time clock 918 tracks a time of day, day of a week, month of a year, and/or year. This real time clock 918 enables the controller in certain embodiments to coordinate with calendar information to determine actions to take in relation to the banner display.

“Storage device” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like. “Memory” refers to any hardware, circuit, component, module, logic, device, or apparatus configured, programmed, designed, arranged, or engineered to retain data. Certain types of memory require availability of a constant power source to store and retain the data. Other types of memory retain and/or store the data when a power source is unavailable.

In one embodiment, the storage subsystem 916 includes a volatile memory 922 and a non-volatile memory 924. The volatile memory 922 and/or the non-volatile memory 924 may store computer-executable instructions that alone or together form logic 926 that when applied to, and executed by, the processor(s) 914 implement embodiments of the processes disclosed herein. “Instruction” refers to a single operation of a processor defined by the processor instruction set. “Volatile memory media” refers to any hardware, device, component, element, or circuit configured to maintain an alterable physical characteristic used to represent a binary value of zero or one for which the alterable physical characteristic reverts to a default state that no longer represents the binary value when a primary power source is removed or unless a primary power source is used to refresh the represented binary value. Examples of volatile memory media include but are not limited to dynamic random-access memory (DRAM), static random-access memory (SRAM), double data rate random-access memory (DDR RAM) or other random access solid state memory

While the volatile memory media is referred to herein as “memory media,” in various embodiments, the volatile memory media may more generally be referred to as volatile memory.

In certain embodiments, data stored in volatile memory media is addressable at a byte level which means that the data in the volatile memory media is organized into bytes (8 bits) of data that each have a unique address, such as a logical address. “Volatile memory” refers to a shorthand name for volatile memory media. In certain embodiments, volatile memory refers to the volatile memory media and the logic, controllers, processor(s), state machine(s), and/or other periphery circuits that manage the volatile memory media and provide access to the volatile memory media. “Non-volatile memory media” refers to any hardware, device, component, element, or circuit configured to maintain an alterable physical characteristic used to represent a binary value of zero or one after a primary power source is removed. “Non-volatile memory” refers to shorthand name for non-volatile memory media. In certain embodiments, non-volatile memory media refers to the non-volatile memory media and the logic, controllers, processor(s), state machine(s), and/or other periphery circuits that manage the non-volatile memory media and provide access to the non-volatile memory media. “Logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The input device(s) 910 include devices and mechanisms for inputting information to the data processing system 904. These may include a keyboard, a keypad, a touch screen incorporated into the graphical user interface 902, audio input devices such as voice recognition systems, microphones, and other types of input devices. In various embodiments, the input device(s) 910 may be embodied as a computer mouse, a trackball, a track pad, a joystick, wireless remote, drawing tablet, voice command system, eye tracking system, and the like. The input device(s) 910 typically allow a user to select objects, icons, control areas, text and the like that appear on the graphical user interface 902 via a command such as a click of a button or the like.

The output device(s) 912 include devices and mechanisms for outputting information from the data processing system 904. These may include the graphical user interface 902, speakers, printers, infrared LEDs, and so on, as well understood in the art. In certain embodiments, the graphical user interface 902 is coupled to the bus subsystem 920 directly by way of a wired connection. In other embodiments, the graphical user interface 902 couples to the data processing system 904 by way of the communication network interface 908. For example, the graphical user interface 902 may comprise a command line interface on a separate computing device 900 such as desktop, server, or mobile device.

The communication network interface 908 provides an interface to communication networks (e.g., communication network 906) and devices external to the data processing system 904. The communication network interface 908 may serve as an interface for receiving data from and transmitting data to other systems. Embodiments of the communication network interface 908 may include an Ethernet interface, a modem (telephone, satellite, cable, ISDN), (asynchronous) digital subscriber line (DSL), FireWire, USB, a wireless communication interface such as Bluetooth or WiFi, a near field communication wireless interface, a cellular interface, and the like.

The communication network interface 908 may be coupled to the communication network 906 via an antenna, a cable, or the like. In some embodiments, the communication network interface 908 may be physically integrated on a circuit board of the data processing system 904, or in some cases may be implemented in software or firmware, such as “soft modems”, or the like.

The computing device 900 may include logic that enables communications over a network using protocols such as HTTP, TCP/IP, RTP/RTSP, IPX, UDP and the like.

The volatile memory 922 and the non-volatile memory 924 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 922 and the non-volatile memory 924 may be configured to store the basic programming and data constructs that provide the functionality of the disclosed processes and other embodiments thereof that fall within the scope of the present invention. Memory 928 and non-volatile memory media 930 also connect to the bus subsystem 920.

In one embodiment, the memory 928 includes non-volatile memory 924 configured to store calendar information. For example, the calendar information may be organized in a data structure such as an object, a list, an array, or the like. The calendar information may comprise a schedule associated with a calendar. Calendar information in non-volatile memory 924 may be referenced or loaded into memory 928 to determine whether clock information satisfies the calendar information.

In one embodiment, when the clock information satisfies the calendar information, the controller sends control signals to activate a motor in the banner display to rotate a shaft in a first direction (e.g., first direction 212 See FIG. 2). The calendar information may include data such as a schedule that defines a trigger condition for extending a banner, but the same schedule or a different set of calendar information or another configuration rule may define another trigger condition for retracting the banner.

For example, the calendar information may include a schedule that causes the controller to extend the banner when the clock information indicates a particular time of a particular day of a particular year and month. In addition, this same schedule, or a different schedule, may define a trigger condition that includes calendar information for when the controller is to retract the banner. Suppose for example, that the calendar information included a schedule defining a trigger condition that the banner is to be displayed for the first Monday of the month. The same schedule may also be configured to not display a particular banner when the date is not the first Monday of the month. In such an example, when the clock information indicates that the time of day no longer satisfies the trigger condition that the banner is to be displayed for the first Monday of the month, such clock information is referred to herein as subsequent clock information. In response to the subsequent clock information the controller may signal the motor to rotate the shaft in a second direction, opposite of the first direction in order to retract the banner.

Logic 926 that implements one or more parts of embodiments of the solution may be stored in the volatile memory 922 and/or the non-volatile memory 924. Logic 926 may be read from the volatile memory 922 and/or non-volatile memory 924 and executed by the processor(s) 914. The volatile memory 922 and the non-volatile memory 924 may also provide a repository for storing data used by the logic 926.

The volatile memory 922 and the non-volatile memory 924 may include a number of memories including a main random access memory (RAM) for storage of instructions and data during program execution and a read only memory (ROM) in which read-only non-transitory instructions are stored. The volatile memory 922 and the non-volatile memory 924 may include a file storage subsystem providing persistent (non-volatile) storage for program and data files. The volatile memory 922 and the non-volatile memory 924 may include removable storage systems, such as removable flash memory.

The communication network 906 may connect to a remote device 932 as described in detail herein. The remote device 932 may transfer operation data 936, including but not limited to, data related to operation of the banner display, via the communication network 906 and the communication network interface 908 to a communication module 934 on the computing device 900, e.g., within the controller.

In one embodiment, the computing device 900 comprises a remote device such as a mobile device and the controller comprises logic in the computing device 900. In such an embodiment, the controller is coupled to a communication module in the banner display by way of a communication channel or link.

The bus subsystem 920 provides a mechanism for enabling the various components and subsystems of data processing system 904 communicate with each other as intended. Although the communication network interface 908 is depicted schematically as a single bus, some embodiments of the bus subsystem 920 may utilize multiple distinct busses.

It will be readily apparent to one of ordinary skill in the art that the computing device 900 may be a device such as a smartphone, a desktop computer, a laptop computer, a rack-mounted computer system, a computer server, or a tablet computer device. As commonly known in the art, the computing device 900 may be implemented as a collection of multiple networked computing devices. Further, the computing device 900 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment). “Firmware” refers to Software logic embodied as processor-executable instructions stored on volatile memory media and/or non-volatile memory media. “Hardware” refers to Logic embodied as analog and/or digital circuitry. “Software” refers to Logic implemented as processor-executable instructions in a machine memory (e.g. read/write volatile memory media or non-volatile memory media).

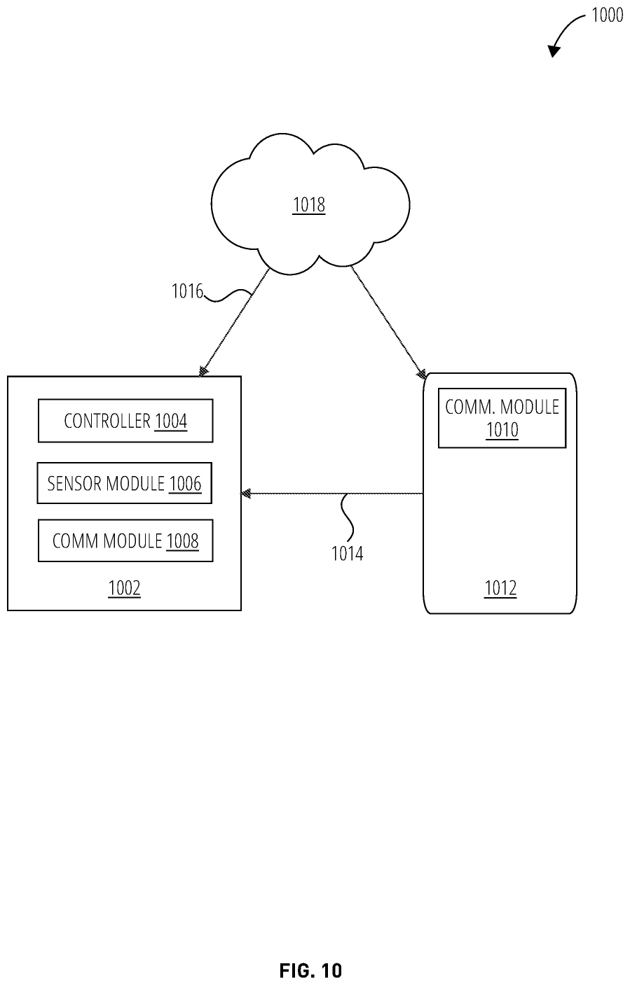

Referring to FIG. 10, a networked environment 1000 that uses a smart banner display 1002 is illustrated. In this embodiment, the smart banner display 1002 includes a controller 1004 and one or more sensor modules 1006.

In the illustrated embodiment, the smart banner display 1002 comprises a communication module having two parts. A first part, is a communication module 1008 within the smart banner display 1002 and a second part is a communication module 1010 in a mobile device 1012. Together the communication module 1008 and communication module 1010 collaborate to exchange messages between the smart banner display 1002 and the mobile device 1012.

In certain embodiments, the smart banner display 1002 and the mobile device 1012 communicate over a direct connection 1014. In another embodiment, the smart banner display 1002 and the mobile device 1012 communicate over an indirect connection 1016 by way of a network 1018. In another embodiment, the smart banner display 1002, mobile device 1012, and respective communication module 1008 and communication module 1010 are configured to adapt and communicate over a direct connection 1014 or an indirect connection 1016.

The smart banner display 1002 further includes a controller 1004 for controlling features and functions of the smart banner display 1002 and a sensor module 1006 for receiving sensory input and providing it to the controller 1004. The controller 1004 may be a microcontroller or other controller. The controller 1004 may perform a banner display 100 action (e.g. actuating the scroll, turning on the lighting, etc.) or modification (e.g. updating an event trigger) based on the sensory input and/or based on commands from the mobile device 1012. A user may interact with an application running on the mobile device 1012 to manage, control, or operate the smart banner display 1002.

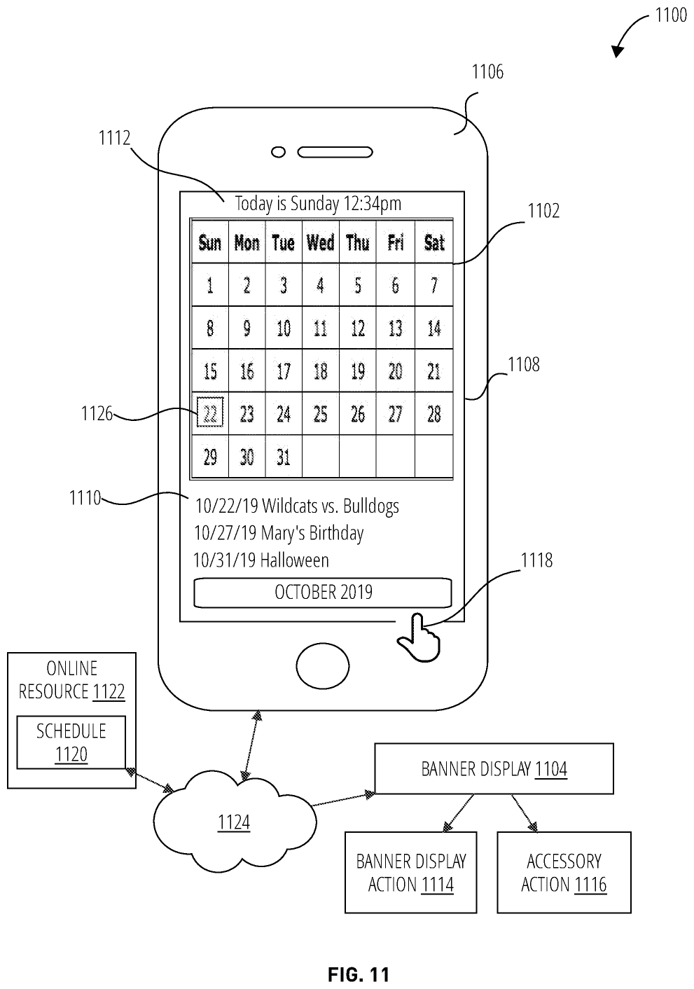

Referring to FIG. 11, a banner display use case 1100 is illustrated. Calendar information 1102, available from a variety of sources, may be managed for a banner display 1104. In one embodiment, a remote device 1106 executes a software application 1108 configured with a calendar feature. The calendar feature may permit display, addition, deletion, and modification of calendar information 1102. In addition, the software application 1108 may include one or more schedules, such as a schedule 1110. “Schedule” refers to a plan, timeline, outline, or series of times, dates, or dates and times for a particular event, activity, or celebration.

In this manner, the software application 1108 manages calendar information for the banner display 1104 based on input from a user. In certain embodiments, the software application 1108 may implement certain logic of the controller, described in different embodiments herein.

In one embodiment, the software application 1108 reviews clock information 1112 such as a current date and/or time of day and determines whether the given time and/or date satisfy one or more schedules that are part of the calendar information 1102. In one embodiment, if the current date and/or time satisfy a schedule, the software application 1108 may trigger a banner display action 1114. “Banner display action” refers to any action that a banner display is configured to perform either alone or in combination with one or more accessories and/or one or more sensors. Examples of a banner display action include, but are not limited to, displaying a banner, retracting a banner, positioning the banner, changing lighting for a banner, partially displaying a banner, partially retracting a banner, playing an audio clip, sounding an alert, a determination whether environmental conditions support displaying or retracting a banner, a determination whether a time of day satisfies a schedule for displaying or retracting a banner, and the like. The banner display action 1114 may comprise one or more of a variety of actions including, but not limited to, raising a banner, lowering a banner, re-positioning a banner to half-staff, and the like.

In another embodiment, the software application 1108 may trigger a banner display action 1114, if the current date and/or time satisfy a schedule and one or more other trigger conditions are satisfied. One example of a trigger condition may be whether there are overcast skies. Another example of a trigger condition may be whether a particular sports team won their last match or game. Those of skill in the art will recognize that given the one or more sensors of the banner display 1104 and the calendar information a variety of trigger conditions may be defined for one or more actions by the banner display 1104, such as a banner display action 1114.

In one embodiment, the software application 1108 may trigger a banner display action 1114 based on one or more factors, events, or activities, including but not limited to, the location of the remote device 1106 relative to the banner display 1104, the occurrence of a particular event, such as sports team winning a sporting event, motion in a vicinity of the banner display 1104, news of a local, regional, or national event such as a political race, an Olympic event, a presidential order regarding displaying of flags, or the like.

In another embodiment, the software application may trigger an accessory action 1116 alone, or in connection with a banner display action 1114, if the current date and/or time satisfy a schedule and one or more other trigger conditions are satisfied. An accessory action 1116 is any action involving one or more accessories within, or coupled to, the banner display 1104. For example, one accessory action 1116 may be to illuminate a spotlight on the banner. Another accessory action 1116 may be to play an audio clip or audio message. Another accessory action 1116 may be to change a color scheme for one or more lighting elements.

In one embodiment, the calendar information, including one or more schedules may be modified, adjusted, or configured in a variety of ways using the software application. First, in one embodiment, calendar information 1102 and/or a schedule 1110 may be modified in response to direct user input 1118, e.g., a user may selectively display either calendar information 1102 (e.g., by month, day, etc.) or an associated schedule 1110, or both, and change or more aspects of the calendar information 1102 and/or schedule 1110. “User input” refers to any gesture, data, command, indication, selection, signal, motion, or activity of a user or parts of a user's body with a computing device. User input may be provided using a user's, finger(s), hand(s), eye(s), ear(s), brain, arm(s), leg(s), feet, voice, eye movement, of the like. A computing device may collect, gather, receive, or otherwise obtain user input using one or more peripherals including, but not limited to, a keyboard, a mouse, a touch screen, a video camera, a motion detector, a brain activity sensor, and the like. User input includes selection or activation of user interface elements, including but not limited to, selections relating to control of a banner display, icons, buttons, keys, switches, links, and the like presented to a user. Once changed, the banner display 1104 may operate based on the changed calendar information 1102 and/or schedule 1110. Additionally, the remote device 1106 may import a new, or changed, schedule 1120 from an online resource 1122 through a network 1124, which may be a server-based calendar centrally maintaining schedule information, for example across a plurality of collaborating users within an organization. “Online resource” refers to a source of calendar information or similar data accessible to computing devices over a private or public network. The banner display 1104 may change calendar information 1102 based on the imported schedule 1120. Once changed, the banner display 1104 may operate based on the changed calendar information 1102 and/or schedule 1120.

In one embodiment, the schedule 1120 from an online resource 1122 comprises a sporting event schedule published on the internet by a sports team. The schedule 1120 may indicate when the sports team plays and whether the game is being played at home or away. The banner display 1104 may implement a different banner display action 1114 based on whether the sports team is playing at home or away.

In one embodiment, a controller of the banner display 1104 may communicate with the online resource 1122 to identify and retrieve a schedule 1120. Alternatively, or in addition, a software application on a remote device may communicate with the online resource 1122 to identify and retrieve a schedule 1120. In another embodiment, the online resource 1122 may push a new or updated schedule 1120 to the banner display 1104 and/or a controller associated with the banner display 1104.

In one embodiment, the banner display 1104 triggers a banner display action 1114 when one or more of the schedule(s), e.g., schedule 1110, schedule 1120, are satisfied by the current date 1126—that is, the current date 1126 matches an event on the schedule 1110. In one embodiment, the software application may send a control signal to the banner display 1104 to trigger the banner display action 1114.

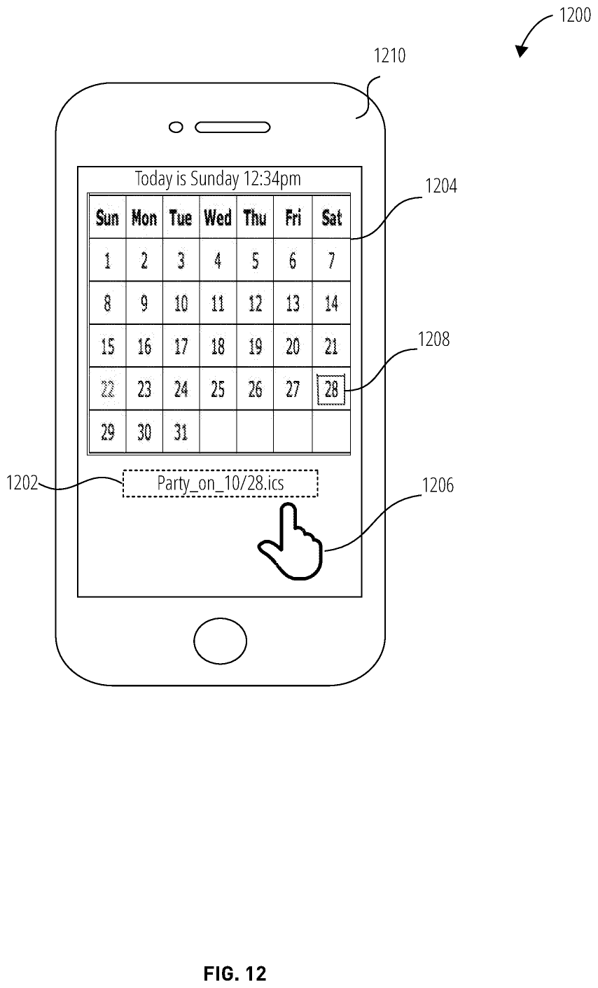

Referring to FIG. 12, a banner display use case 1200 is illustrated. In one embodiment, a user may designate a calendar export file 1202, which may be resident on a remote device 1210 or acquired over a network. “Calendar export file” refers to a data file (i.e., a collection of computer-readable digital data) containing dates, days, times and user-designated events with the ability to be designated as user input to a method managing calendar information (e.g., scheduled dates) for a banner display. The calendar export file 1202 comprises calendar information 1204 and may include one or more schedules for various events and with a file format well known to those skilled in the art (e.g., *.ics format).

Upon selecting the calendar export file 1202 via user input 1206, a software application, such as a controller in one embodiment, may import the calendar export file 1202 and update the calendar information 1204 resident on the remote device 1210 updates based on events, schedule(s), and/or information contained in the calendar export file 1202. That is, each imported event 1208 from the calendar export file 1202 is integrated with the resident calendar information 1204 and displays on user input 1206 on the remote device 1210. “Imported event” refers to a textual representation of an action taking place at a specific time, day, or date and copied or transferred to a computing device over a network or other means of data or file transfer.

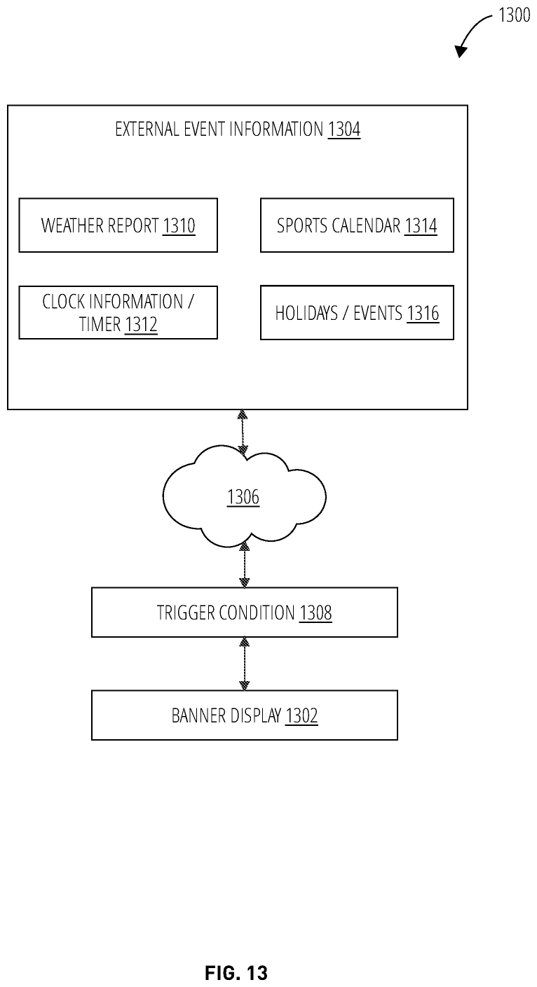

Referring to FIG. 13, a banner display use case 1300 is shown. In one embodiment, a controller for a banner display 1302 may monitor external event information 1304 over a network 1306 for any changes or for new conditions. “External event information” refers to data, information, sensor readings, sensor input, or the like that activate a trigger condition on which a banner display action may be based. In one embodiment, external event information comprises online event information available from an online resource.

FIG. 13 illustrates four examples of external event information 1304: a weather report 1310, a clock information/timer 1312, a sports calendar 1314, a schedule of holidays/events 1316, and the like.

The monitoring may be done on a schedule or in response to user input or in response to some other rule or configuration setting. For example, the controller may perform the monitoring using a heartbeat application (e.g., periodic check for a condition change) or other means to detect a change in external event information 1304 (e.g., weather monitoring equipment). In another example, changes to external event information 1304 may be pushed to the controller on a periodic basis or after the external event information changes.

Trigger conditions, such as trigger condition 1308 may be defined by a user, be defined within calendar information, or the like. In one embodiment, a trigger condition 1308 comprises a data structure stored on the banner display 1302. In another embodiment, a trigger condition 1308 comprises a data structure stored with a controller on a remote device. In another embodiment, a trigger condition 1308 comprises a data structure stored on a server in communication with a controller for the banner display 1302.

Those of skill in the art will appreciate that trigger conditions may be of different types and varieties. In one embodiment, a controller of the banner display 1302 and/or a software application 1108 may interface with user in order to define, remove, revise, or configure a trigger condition 1308. Further, a controller of the banner display 1302 and/or a software application 1108 may be configured with logic to trigger a banner display action 1114 based on one or more factors, events, or activities, including but not limited to, the location of a remote device 1106 relative to the banner display 1104, the occurrence of a particular event, such as sports team winning a sporting event, motion in a vicinity of the banner display 1104, news of a local, regional, or national event such as a political race, an Olympic event, a presidential order regarding displaying of flags, or the like.

In certain embodiments, one trigger condition may override other trigger conditions that are also satisfied. For example, if an owner of the banner display sets a trigger condition 1308 for the banner display to display a banner celebrating the owner's birthday, such a trigger condition 1308 may be configured to override any other trigger conditions that the banner display may detect. For example, the display of this banner for the owner's birthday may remain displayed even if trigger condition relating to raining weather would have caused the banner display to retract the banner celebrating the owner's birthday.

A trigger condition 1308 may use one or more of the types of external event information 1304. In one example, a trigger condition 1308 is setup for a sports calendar 1314. The trigger condition 1308 may define that if a sports team plays on a particular date and a weather report 1310 is for good weather, then the banner display 1302 will display the banner.

Another type of external event information 1304 may comprise a news feed and a trigger condition 1308 may be setup such that if a particular sports team wins a match by more than a threshold number of points, the banner display 1302 displays the banner and plays an audio clip such as the team's song. In this example, the banner display action is display of the banner and playing of the audio clip. If the trigger condition 1308 is not satisfied, then the banner display 1302 may take no action.

In block 1402, item 1400 manages calendar information for a banner display, the calendar information comprising a schedule. In block 1404, item 1400 determines whether a current date satisfies the schedule. In block 1406, item 1400 triggers a banner display action by a banner display in response to the current date satisfying the schedule.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Selector” refers to any hardware, device, component, element, or circuit configured to decouple a motor from one shaft and engage the motor to a different shaft.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

What is claimed is:

1. An apparatus comprising:
a housing;
a shaft extending from the housing and configured to rotate relative to the housing;
a banner coupled to the shaft such that the banner extends away from the shaft as the shaft rotates in a first direction;
a motor configured to rotate the shaft in response to control signals from a controller; and
a controller configured to send control signals configured to activate the motor to rotate the shaft in the first direction in response to clock information satisfying calendar information.

2. The apparatus of claim 1, wherein the controller is further configured to send control signals to activate the motor to rotate the shaft in a second direction in response to subsequent clock information satisfying the calendar information.

3. The apparatus of claim 1, wherein the controller comprises,
a memory comprising non-volatile memory media configured to store calendar information;
a real time clock configured to manage the clock information; and
a processor configured to send the control signals when clock information satisfies the calendar information.

4. The apparatus of claim 1, further comprising a communication module coupled to the controller, the communication module configured to communicate with a remote device, the remote device configured to exchange operation data with the controller.

5. The apparatus of claim 1, wherein the shaft is removably coupled to the motor.

6. A system comprising:
a housing;
a shaft within the housing;
a banner coupled to the shaft such that one end of the banner extends away from the shaft and retracts towards the shaft as the shaft rotates in opposite directions; and
a motor located within the housing, the motor configured to rotate the shaft based on control signals from a controller configured to manage calendar information and clock information, the controller configured to send control signals to the motor to rotate the shaft in one direction in response to the clock information satisfying a schedule based on calendar information.

7. The system of claim 6, wherein the controller resides within the housing, the system further comprising a communication module coupled to the controller, the communication module configured to communicate with a remote device, the remote device configured to exchange operation data with the controller.

8. The system of claim 6, comprising one or more sensors coupled to the controller.

9. The system of claim 8, wherein the one or more sensors comprises a banner position sensor.

10. The system of claim 6, comprising one or more accessories coupled to the controller.

11. The system of claim 6, comprising a banner identifier coupled to the controller, the controller configured to change a rotation count for the shaft based on the banner identifier.

12. The system of claim 6, wherein the banner is removably attached to the shaft such that the shaft is useable with a plurality of banners.

13. The system of claim 6, further comprising a mounting system configured to connect the housing to a mount site.

14. The system of claim 6, further comprising a plurality of shafts within the housing, each shaft connected to a banner, the system comprising a selector configured to selectively engage one of the shafts with the motor, in response to a control signal from the controller.

15. A method comprising:
managing calendar information for a banner display, the calendar information comprising a schedule;
determining whether a current date satisfies the schedule; and
triggering a banner display action by a banner display in response to the current date satisfying the schedule.

16. The method of claim 15, modifying the schedule in response to user input; and
managing presentation of a banner of the banner display based on clock information and the schedule.

17. The method of claim 15, wherein the user input comprises designation of a calendar export file and modifying the calendar information comprises importing the calendar export file and changing the calendar information based on imported events in the calendar export file.

18. The method of claim 15 further comprising
monitoring external event information; and
trigger the banner display action based on a trigger condition, the trigger condition comprising the external event information.

19. The method of claim 15 further comprising
receiving a schedule in response to user input;
triggering a banner display action by the banner display in response to the current date satisfying the received schedule.

20. The method of claim 15 further comprising
importing a schedule from an online resource;
triggering a banner display action by the banner display in response to the current date satisfying the imported schedule.
